(19) United States
(12) Patent Application Publication
(10) Pub. No.: US 2008/0131145 A1
(43) Pub. Date: Jun. 5, 2008

(54) Image forming apparatus

(75) Inventors: Kozo Tao, Osaka (JP); Takuya Tsuji, Osaka (JP)

Correspondence Address: DILWORTH & BARRESE, LLP, 333 EARLE OVINGTON BLVD., SUITE 702, UNIONDALE, NY, 11553, US

(73) Assignee: KYOCERA MITA CORPORATION, Osaka (JP)

(21) Appl. No.: 11/977,685

(22) Filed: Oct. 25, 2007

(30) Foreign Application Priority Data
Oct. 26, 2006 (JP) 2006-290730

(51) Int. Cl. G03G 15/00

(52) U.S. Cl. 399/21

(57) ABSTRACT

An image forming apparatus to inhibit resources from being wastefully consumed with the occurrence of a jam is provided. When a jam occurs in a paper feeding section while duplex printing is being performed, stop preparation information is transmitted from an engine control section 206 to a main control section 200 (step S309). Upon receipt of the stop preparation information, the main control section 200 transmits a request to delete a printing request that has already been transmitted (step S310), and re-requests printing for a page corresponding to a sheet of paper that can be recovered by duplex printing (step S312). The engine control section 206 notifies, upon receipt of image data on the page for which the main control section 200 requests printing to complete the duplex printing (step S318), a user of a jam (step S319).

This application is based on and claims the benefit of priority from Japanese Patent Application No. 2006-290730, filed on 26 Oct. 2006, the content of which is incorporated herein by reference.

### BACKGROUND OF THE INVENTION

1. Field of the Invention

The present invention relates to image forming apparatuses such as a copying machine, a facsimile transmitter-receiver, and a printer, each of which prints an image formed on the basis of image data on a medium such as paper and, more particularly, to an image forming apparatus having a function of printing on both surfaces of paper.

2. Related Art

Image forming apparatuses of this type have duplex printing functions capable of not only printing images on only one surface of paper, but also printing images on both surfaces thereof. The duplex printing functions are realized by inverting paper having images printed on one surface thereof without discharging the paper and printing on the other surface thereof.

In the image forming apparatuses of this type, when paper jams occur during printing, the printing is resumed after stopping operation as a machine once to remove the paper that has jammed. In thus resuming the printing, the related art for previously holding jam backup information relating to a plurality of pages and reforming image data for the page on which a paper jam has occurred to do printing has been known. In the related art, when a paper jam occurs in a duplex printing mechanism, jam backup processing can be performed by making a user choose by way of a display whether or not a duplex printing mode is to be released after the paper jam is released, and releasing, when the user chooses that the duplex printing mode is to be released, the duplex printing mode. In this case, printing on only one surface of the paper is done using image data that has been backed up. Therefore, it is considered that the image data is not discarded and image data need not be re-transmitted from outside the image forming apparatus.

Conventionally, in the image forming apparatuses of this type, when jams occur while duplex printing is being performed, operations of stopping the printing at the time points, automatically discharging paper during printing, and notifying a user that a jam has occurred are generally performed. In addition, in the abovementioned related art, when a jam occurs, single side printing can be performed by stopping the operation once and performing jam backup processing after restoration. Particularly, the printing itself is continued without delay. From the viewpoint of a user who consistently desires to do duplex printing, however, the result of the single-sided printing is not what the user had expected. Eventually, the paper that has been subjected to the single-sided printing must be discarded to redo duplex printing. Therefore, in the related art, paper resources, toner, etc. are wastefully consumed.

Therefore, an objective of the present invention is to provide technologies for preventing resources from being wastefully consumed with the occurrence of a jam.

### SUMMARY OF THE INVENTION

The present invention relates to an image forming apparatus including an image forming section for forming an image on the basis of image data processed page-by-page. The image forming apparatus according to the present invention can print the unit-page image formed in the image forming section on one surface of a sheet of paper, then also print the unit-page image on the other surface of the same sheet of paper, and discharge the sheet of paper. It should be noted that the unit-page image corresponds to one surface of one sheet of paper (one page).

Furthermore, the image forming apparatus according to the present invention feeds a required number of sheets of paper one at a time to the image forming section in response to a request to print the unit-page image for each surface of the sheet of paper in controlling a printing operation performed by the image forming section. If there is a request to do printing on one surface and the other surface of the one sheet of paper, respectively, for example, the one sheet of paper is fed in response to the request. Furthermore, if there is a request to do printing on the other sheet of paper (second sheet of paper), the second sheet of paper is fed in response to the request. When the request to print an image on both of the surfaces of the one sheet of paper is issued, as described above, the sheet of paper having the image, printed by the image forming section, on its one surface is inverted and is fed to the image forming section with the printing on the other surface thereof, as allowed by the present invention.

Particularly in the present invention, when an obstruction that has occurred in the process of paper feeding is detected as a jam, if the sheet of paper having the image printed by the image forming section on one surface thereof exists by that point in time, printing on the other surface thereof can be completed.

In this case, the sheet of paper during the feeding process has not reached the image forming section yet. Therefore, printing is done on neither of the surfaces of the sheet of paper. That is, the jam that occurs at this point in time does not restrict the movement of the sheet of paper having the image previously printed on its one surface. Therefore, in the present invention, even when a jam occurs, the sheet of paper having the image only printed on its one surface is not merely discharged, but is discharged upon completion of duplex printing thereof. Therefore, in the present invention, printing can be done on both of the surfaces of the one sheet of paper on the basis of the original request, and the discharged sheet of paper can be effectively made use of.

Particularly, in the present invention, processes are carried out in the following order.

In a first aspect, even if a request to perform printing has already been issued in controlling a printing operation when a jam is detected, as described above, the request at which the image forming section has not performed a printing operation yet is cancelled.

In a second aspect of when the request is cancelled in the foregoing first aspect, a re-request to perform a printing operation for the other surface of a sheet of paper having an image printed, by the image forming section, on its one surface is issued again.

In a third aspect of the present invention, when the re-request is issued in the foregoing second aspect, and the printing operation based on the re-request is terminated, the subsequent printing operation by the image forming section is stopped, and a user is notified of the occurrence of the jam.

When the processes are carried out in the foregoing order, duplex printing is normally performed for all the sheets of paper discharged from the image forming apparatus. Therefore, the user can effectively make use of the result of the duplex printing. In this case, no re-request is issued to perform printing on the sheet of paper that has jammed. Therefore, the sheets of paper are not further fed. Consequently, the jam is prevented from being repeated in response to the re-request. Furthermore, the user can identify that the jam has occurred by the notification. After the cause of the jam is removed, the image forming apparatus can continue to perform a normal printing operation.

More practically, when the printing control means controls the printing operation performed by the image forming section, a control means serving as one element can have the function of requesting printing, cancelling the request when the jam is detected, and re-requesting the subsequent printing. When the jam is detected, the printing control means transmits a stop preparation signal to the control means in preparation for the stop of the subsequent printing operation by the image forming section, and the control means cancels the request and re-requests printing upon receipt of the stop preparation signal.

In this case, the following processes are carried out through exchange between the “printing control means” and the other “control means”.

(1) First, the printing control means preliminarily notifies the control means of stop preparation information relating to a printing operation due to the occurrence of a jam.

(2) Upon receipt of the stop preparation information, the control means judges a page required to discharge sheets of paper without any problem with duplex printing completed, and re-requests printing by unit-page. If printing on one surface of the first sheet of paper is done, for example, a re-request to do printing is issued for a page corresponding to the other surface of the same sheet of paper.

(3) The printing control means does duplex printing for the page to which the re-request is issued. Duplex printing is completed, as originally requested, on the sheets of paper discharged through the foregoing processes.

The image forming apparatus according to the present invention may further include a finishing-processing section for performing predetermined finishing-processing for the sheet of paper discharged with the printing operation by the image forming section completed. In this case, an obstruction that has occurred in the process of the finishing-processing performed for the sheet of paper discharged into the finishing-processing section can be detected as a jam. It should be noted that the finishing-processing is processing for forming a punching hole (punching a hole) in sheets of paper after printing and binding and stapling the sheets of paper. In the processing, an operation of conveying and stacking sheets of paper is performed, so that any jam may occur in the process of the operation.

Similarly, in this case, a jam that has occurred in the process of the finishing-processing is not an obstruction to the subsequent duplex printing. In the present invention, if there has already been a sheet of paper having an image printed on one surface thereof, the duplex printing is completed for the sheet of paper. In this case, however, it is desirable that not the finishing-processing section but another destination of discharge (a paper discharging section in the image forming apparatus) is designated as a destination of discharge of the sheet of paper after printing.

When a jam occurs in the process of inverting and feeding the sheet of paper for duplex printing, the duplex printing cannot be continued unless the jam is removed. When the other sheet of paper is newly fed at the point in time, however, it is desirable that the sheet of paper is discharged after printing on only one surface thereof is done.

Therefore, in the present invention, when an obstruction that has occurred in the process of inverting and feeding a sheet of paper having an image printed on one surface thereof is detected as a duplex printing jam, and particularly when a sheet of paper having no problem exists in the process of paper feeding, the sheet of paper is forcibly discharged with printing completed on one of the surfaces, even if a request to do printing on both surfaces of the sheet of paper is issued. This allows the sheet of paper to be discharged without causing sheet of paper to stay during the process of paper feeding and with any output.

As described in the foregoing, the image forming apparatus according to the present invention can discharge, if there is a sheet of paper that can be still manipulated when a jam occurs during duplex printing, the sheet of paper after realizing normal duplex printing before a printing operation is stopped. This can prevent the sheet of paper from being discharged in an incomplete state (a state where printing is completed on only one surface thereof against a request to do duplex printing) and allows the waste of paper resources and toner from being reliably eliminated.

Even if normal printing cannot be continued, if a sheet of paper that can be discharged after a jam occurs remains, the sheet of paper can be discharged after printing is completed thereon, which allows a further jam to be reliably avoided.

### BRIEF DESCRIPTION OF THE DRAWINGS

FIG. 1 is an explanatory view showing the overall configuration of an image forming apparatus;

FIG. 2 is a block diagram schematically showing the control configuration of an image forming apparatus;

FIG. 3 is a sequential view of an operational example 1;

FIG. 4 is a schematic view showing an example in which a finisher is combined with an image forming apparatus to configure one image forming system;

FIG. 5 is a sequential view of an operational example 2; and

FIG. 6 is a sequential view of an operational example 3.

### BEST MODE FOR CARRYING OUT THE INVENTION

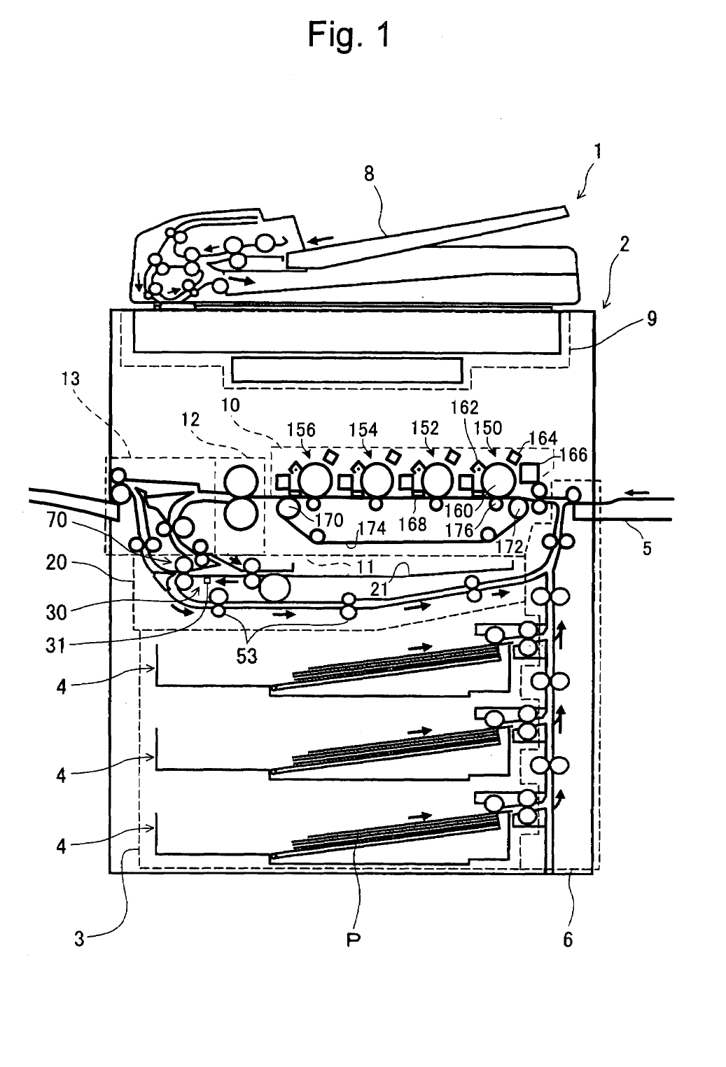

Best modes for carrying out the present invention are described in detail with reference to the drawings. FIG. 1 is an explanatory view showing the configuration of an image forming apparatus 1 according to the present embodiment. The image forming apparatus 1 is a reproduction apparatus having a copying function, for example, for performing a printing operation of printing an image on a sheet of paper serving as a printing medium on the basis of image data. The image forming apparatus 1 has not only the function of performing printing on one surface of a sheet of paper, but also a duplex printing function of performing printing on both surfaces, i.e., a front surface and a back surface of a sheet of paper. Arrows indicated by a solid line represent a paper conveying path and a paper conveyance direction.

The image forming apparatus 1 includes a main body 2 having components, each of which performs a printing operation, and a cassette-type paper feeding section 3 in which sheets of paper of various sizes are respectively accommodated in a plurality of paper feeding cassettes 4. The cassette-type paper feeding section 3 includes paper feeding cassettes 4 in upper, intermediate, and lower stages (three stages), for example. The paper feeding cassette 4 is of a so-called front loading type. Each of the paper feeding cassettes 4 can be pulled out by sliding toward its front surface (forward FIG. 1) from the main body 2. Furthermore, sheets of paper such as cut sheets of paper before printing are loaded within each of the paper feeding cassettes 4. The sheets of paper (indicated by a symbol P) loaded within the paper feeding cassette 4 are separated and delivered one at a time from the cassette-type paper feeding section 3.

In the paper feeding cassettes 4 in the upper, intermediate, and lower stages, different paper sizes and paper types can be set at their respective positions. For example, the uppermost paper feeding cassette 4, which is taken as a paper feeding stage usually used, can accommodate plain sheets of paper of A4 size that are used at a relatively high frequency. The intermediate paper feeding cassette 4 is used for multipurpose applications, and can accommodate OHP sheets, cartons, thin paper, etc. The lowermost paper feeding cassette 4 can accommodate sheets of paper of sizes larger than A4 size. The size, type, etc. of sheets of paper accommodated in the paper feeding cassette 4 in each of the stages can be previously set in the image forming apparatus 1.

Furthermore, the image forming apparatus 1 includes a manual paper feeding section 5 for manually feeding sheets of paper of a type different from that of the sheets of paper accommodated in the paper feeding cassette 4, for example. Sheets of paper that are delivered one at a time, for example, sheets of paper of sizes different from the sizes of the sheets of paper that can be accommodated in the cassette-type paper feeding section 3, postcards, and envelopes are loaded in the manual paper feeding section 5. It should be noted that the manual paper feeding section 5 may take such a form as to be foldable on a right side surface of the main body 2.

The image forming apparatus 1 further includes a paper conveying section 6 for removing and conveying the sheets of paper accommodated in the cassette-type paper feeding section 3 one at a time. The paper conveying section 6 has a function of conveying the sheets of paper delivered from the cassette-type paper feeding section 3 vertically upward along a side surface of the main body 2 and horizontally conveying the sheets of paper delivered from the manual paper feeding section 5, and conveying the sheets of paper to the transfer section 11.

The image forming apparatus 1 includes a regist roller 7 for delivering the sheets of paper conveyed by the paper conveying section 6 to a print engine 10 at a predetermined timing. The registration roller 7 is mounted immediately to the upstream side of the transferring section 11. The registration roller 7 has a function of correcting the diagonal feeding of sheets of paper as well as delivering the sheets of paper toward the transferring section 11 while synchronizing the sheets of paper with a toner image formed by the print engine 10. In the transferring section 11, the toner image is transferred onto the sheets of paper delivered, while being synchronized with the sheets of paper by the registration roller 7.

The image forming apparatus 1 includes a document feeding section 8 for reading image data with a document to be copied placed thereon and an optical section 9 for optically reading an image from the document placed on the document feeding section 8. When a user copies a document, a document having an image such as characters, figures, patterns, etc. drawn thereon is loaded in the document feeding section 8. When the document contains a plurality of documents, the document feeding section 8 separates and conveys the documents one at a time, and the optical section 9 reads images respectively drawn thereon.

The image forming apparatus 1 includes a print engine 10 for forming a toner image on a sheet of paper on the basis of image data, and a transferring section 11 for transferring the toner image formed by the print engine 10 onto the sheet of paper. The print engine 10 has a function of forming an electrostatic latent image of a document image on the basis of image data obtained by processing the image read by the optical section 9, and further forming a toner image from the electrostatic latent image.

The print engine 10 includes so-called quadruple-tandem type image forming units 150, 152, 154, and 156. The units 150 to 156 form toner images corresponding to colors, i.e., magenta, cyan, yellow, and black, respectively, in this order from the upstream side, when viewed in the paper conveyance direction (leftward in FIG. 1).

Furthermore, each of the image forming units 150 to 156 includes a charging section 162, an exposing section 164, a developing section 166, and a cleaning section 168 that are arranged along a peripheral surface thereof in addition to a drum photoconductor 160 rotated in one direction (a clockwise direction in FIG. 1). Although in FIG. 1 reference numerals of the charging section 162, the exposing section 164, and the developing section 166 are illustrated only with respect to the image forming unit 150 in magenta, and a reference numeral of the cleaning section 168 is illustrated only with respect to the image forming unit 152 in cyan adjacent thereto on the downstream side, the respective configurations of the image forming units 150 to 156 are common. Furthermore, the respective developing sections 166 have corresponding toner boxes (not shown) accommodating magenta, cyan, yellow, and black toner particles.

The transferring section 11 transfers, while revolving a continuous transfer belt 174 in one direction (in a counterclockwise direction in FIG. 1) to convey the sheet of paper, the toner images in the respective colors onto its transfer surface. The transfer belt 174 is stretched over a driving roller 170 and a driven roller 172, and its upper surface on the outer periphery is brought into contact with a peripheral surface of each of the drum photoconductors 160 in the four image forming units 150 to 156. Furthermore, the four transfer rollers 176 corresponding to the drum photoconductors 160, respectively, are mounted on the inner periphery of the transfer belt 174, and the transfer belt 174 is sandwiched between each of the transfer rollers 176 and the corresponding drum photoconductor 160. The sheet of paper conveyed from the paper conveying section 6 is conveyed toward the downstream side (leftward in FIG. 1) with the sheet of paper electrostatically held on the transfer belt 174. In the conveying process, the toner images by color are transferred onto the transfer surface of the sheet of paper.

A pair of registration rollers 7 is for adjusting the timing between an image forming operation and a paper feeding operation in the print engine 10. The registration roller 7 rotates forward in synchronization with the rotation of the drum photoconductor 160 at an upstream position to deliver the sheet of paper onto the transfer belt 174. Then, the toner image on each of the drum photoconductors 160 is transferred onto the sheet of paper as the sheet of paper is conveyed by the transfer belt 174.

The image forming apparatus 1 includes a embedding section 12 for embedding the unfixed toner image that has been transferred onto the sheet of paper. The fixing section 12 heats and presses the sheet of paper on which an unfixed toner image has been supported by the transferring section 11 to embed the toner image.

The image forming apparatus 1 includes a paper discharging/branching section 13 for conveying the sheet of paper having the toner image embedded thereto in order to discharge or duplex-print the sheet of paper, and a paper discharge tray 14 on which the sheet of paper discharged by the paper discharging/branching section 13 is placed. The paper discharging/branching section 13 discharges the sheet of paper conveyed from the embedding section 12 into the paper discharge tray 14 as from the paper discharging/branching section 13 in a case where duplex printing is not performed (a case of single side printing).

The image forming apparatus 1 further includes a duplex printing unit 20 for conveying the sheet of paper conveyed from the paper discharging/branching section 13 to the transferring section 11 again in order to perform duplex printing. The duplex printing unit 20 has a function of switching, when the sheet of paper conveyed from the embedding unit 12 is fed through the paper discharging/branching section 13, the paper conveyance direction using a paper inverter 30 provided inside thereof, and feeding the sheet of paper to the transferring section 11 through the paper conveying section 6 and the registration roller 7 again from this switching point when duplex printing is performed.

The paper inverter 30 includes a switchback mechanism 60 and a shifting mechanism 70. The switchback mechanism 60 is for inverting the paper conveyance direction. Furthermore, the shifting mechanism 70 is for correcting the shift in position in the width direction of the sheet of paper. A sensor 31 for detecting the shift in position in the width direction of the sheet of paper is provided at a position upstream of the shifting mechanism 70, when viewed in the paper conveyance direction.

An intermediate tray 21 is mounted further downstream of the switchback mechanism 60, when viewed in the direction entrance into the paper inverter 30. The intermediate tray 21 temporarily accommodates the sheet of paper having an image printed on one surface thereof. The switchback mechanism 60 is for accommodating the sheet of paper in the intermediate tray 21 once, then switching back the sheet of paper to switch the conveyance direction thereof.

The sheet of paper switched back is inverted, after the position thereof is corrected by the shifting mechanism 70, in such a manner as to be concealed downward at a position downstream thereof in the conveyance direction. The sheet of paper merges into the paper conveying section 6 while slightly obliquely rising after being fed rightward by a plurality of delivery rollers 53 below the transferring section 11 and the print engine (image forming section) 10. Thus, the sheet of paper is fed into the print engine 10 with its surface, on which printing has been previously performed, directed downward, by which printing on both surfaces of the sheet of paper is performed. The sheet of paper that has been subjected to duplex printing is discharged to the paper discharge tray 14 through the paper discharging/branching section 13. Alternatively, the sheet of paper is inverted by the paper inverter 3 again, then is conveyed upward along a left side part of the main body 2, and is discharged into the paper discharge tray 14.

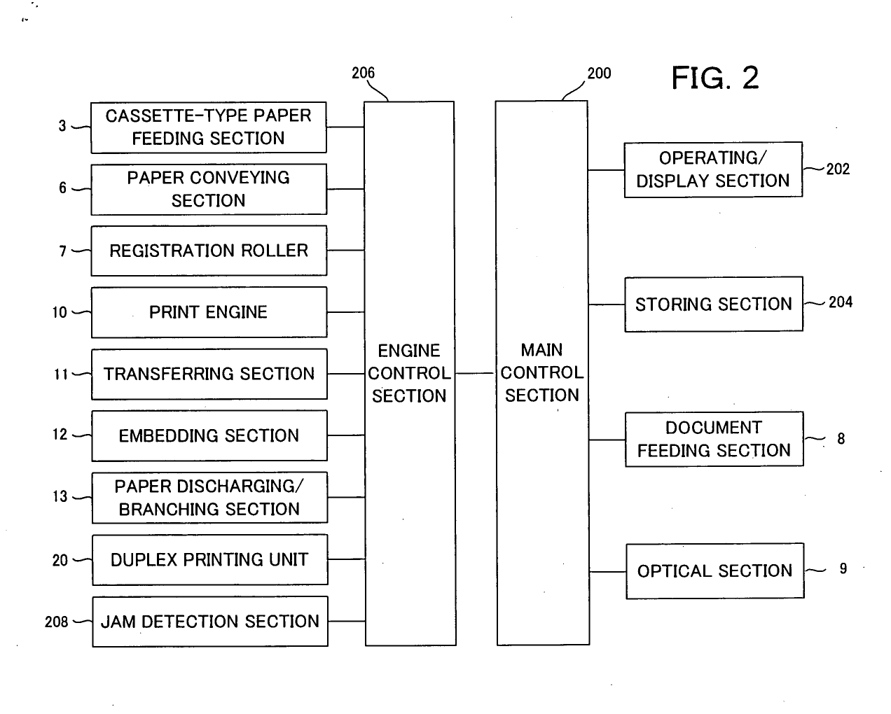

FIG. 2 is a block diagram schematically showing the control configuration of the image forming apparatus 1. The image forming apparatus 1 includes a main control section 200 for controlling the overall operation thereof as well as an engine control section 206 for controlling the operation of the print engine 10. Each of the control sections 200 and 206 is composed of an electronic circuit including a central processing unit (CPU), for example, and is contained in the image forming apparatus 1 with the electronic circuit formed on a circuit board. The main control section 200 and the engine control section 206 perform processing while communicating with each other.

In the present embodiment, the main control section 200 controls a document feeding operation by the document feeding section 8 and an image reading operation in the optical section 9 initiated thereby, for example. Furthermore, the engine control section 206 configured separately from the main control section 200 controls an image forming operation by the print engine 10. Accordingly, the engine control section 206 also controls the respective operations in the registration roller 7, the transferring section 11, the fixing section 12, the paper discharging/branching section 13, and the duplex printing unit 20, in addition to the paper feeding operation from the cassette-type paper feeding section 3 and the paper conveying operation by the paper conveying section 6.

An operating/display section 202 and a storing section 204 are connected to the main control section 200. Furthermore, a jam detection section 208 is connected to the engine control section 206. The operating/display section 202 is provided at a position before the document feeding section 8, when viewed from the user, on an upper surface of the main body 2, which is not shown in FIG. 1. The operating/display section 202 has a touch panel in addition to an operation key, and can accept a touch operation by the user through a display screen in addition to an operation for the operation key and can display character information or the like for notifying the user of the occurrence of a jam. Furthermore, the storing section 204 has storage (ROM, RAM), a large capacity storage (hard disk), or the like. An image read in the optical section 9 is temporarily stored in the storing section 204 in a predetermined data format.

In the image forming apparatus 1, data set through the operation of the operating/display section 202 for each job, for example, is stored in the storing section 204 through the main control section 200. Examples of the setting include paper size, paper type, paper feeding direction, duplex- or single-sided printing format, document density, frame erasure, binding margin, and 4-in-1 aggregate processing. The main control section 200 performs image processing depending on each setting. A time period required for the image forming apparatus 1 to perform the image processing depends on the contents of the setting. The storing section 204 stores an application program for a complex machine that performs multithread processing, for example.

The main control section 200 and the engine control section 206 both control an image forming operation (printing operation) along a predetermined sequence while communicating with each other. In image processing involving copying of a document, for example, when the user presses a start key (not shown) in the operating/display section 202 with the document placed on the document feeding section 8, the following processes are carried out in response to this operation. First, when a paper sensor (not shown) contained in the document feeding section 8 detects document paper, the document feeding section 8 conveys documents one at a time, during which the optical section 9 scans a document image. Image data read at this time is stored in the storing section 204 through the main control section 200. The main control section 200 subjects the image data to preprocessing such as noise reduction of the image, and then transmits the image data to the engine control section 206.

The engine control section 206 further subjects the image data transmitted from the main control section 200 to image processing corresponding to each type of setting, and controls the print engine 10 to form an image on the basis of the image data for each page. This causes an electrostatic latent image to be formed on surfaces of the respective drum photoconductors 160 in the print engine 10, and developed by toner images.

On the other hand, in the image forming apparatus 1, the sheet of paper taken out of the cassette-type paper feeding section 3 is fed into the registration roller 7, where the sheet of paper is stopped once. When the drum photoconductor 160 at the most upstream position 5 rotates to a predetermined angle as the print engine 10 performs an image forming operation, the sheet of paper is conveyed again by the registration roller 7 at this timing. This causes each color toner image to be transferred onto the sheet of paper. The other three drum photoconductors 160 positioned on the downstream side are respectively adjusted to rotation angles that are synchronized with the conveyance speed of the sheet of paper.

When duplex printing is set using the current job, the sheet of paper having the toner images transferred thereon is heated and pressed through the embedding section 12. Thereafter, the conveyance direction of the sheet of paper is branched downward within the paper discharging/branching section 13, and is delivered toward the duplex printing unit 20.

When a jam due to a paper jam or the like occurs in the cassette-type paper feeding section 3, the paper conveying section 6, the registration roller 7, the paper discharging/branching section 13, or the duplex printing unit 20 while such a series of printing operations is being performed, the jam detection section 208 composed of sensors (particularly not illustrated) attached to each of the sections detect the occurrence of the jam, and transmits information relating to the detection to the engine control section 206. The engine control section 206 stops, when the jam detection information is transmitted thereto, an operation of such a machine, and thus performs a previously set operation.

These are the respective basic configuration and operations of the image forming apparatus 1. Additionally, in the present embodiment, when a jam occurs while a printing operation designated by the user as duplex printing using the job is being performed, the following operations are performed between the main control section 200 and the engine control section 206. Some examples (sequence patterns) of the operations performed between the main control section 200 and the engine control section 206 are described below.

### OPERATION EXAMPLE 1

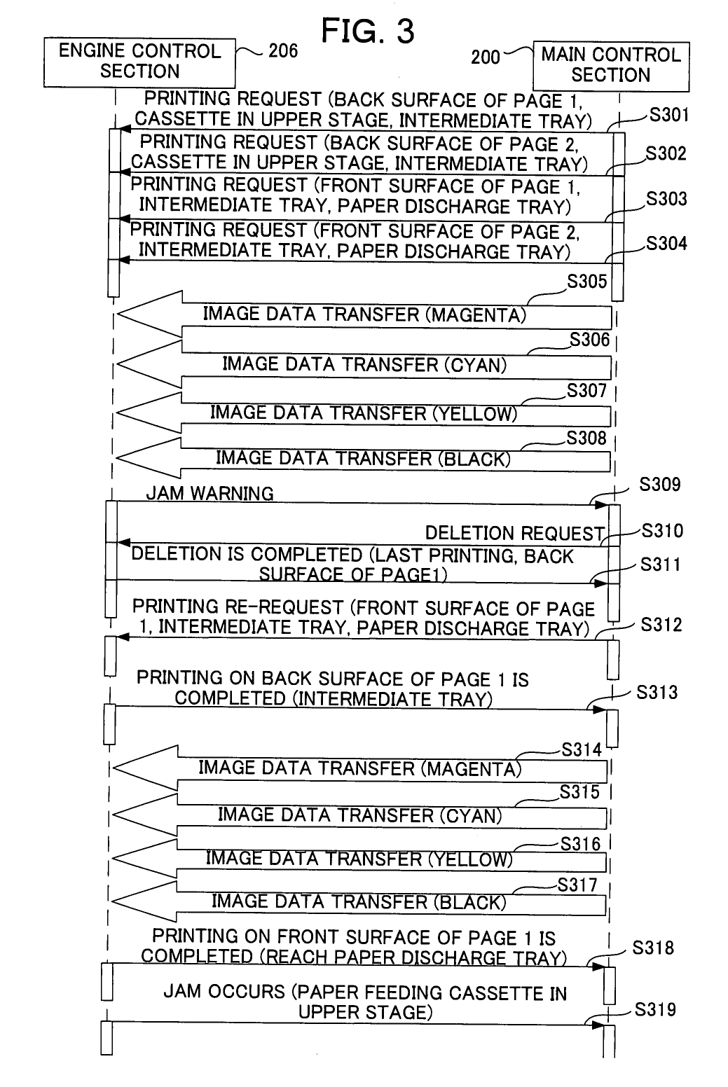

FIG. 3 is a sequential view of an operational example 1. In the operational example 1, a plurality of sheets of paper are subjected to duplex printing while being fed successively from the paper feeding cassette 4 in the same stage. Here, a sequence assuming a case where the first sheet of paper is normally fed, while an obstruction occurs at the time of feeding the second sheet of paper, thereby causing a paper jam, is taken as an example. Such an obstruction occurs due to inferior conveyance, for example, caused by slippage of a paper feeding roller for delivering the sheet of paper at an upper end from the paper feeding cassette 4, and deformation and folding of the sheet of paper.

When a user designates duplex printing using the operating/display section 202 to press the start key in a job involving copying of a document, for example, the main control section 200 causes the optical section 9 to read a document surface of the document and stores image data relating to the document surface in the storing section 204, while causing the document feeding section 8 to automatically feed the document. Additionally, the main control section 200 transmits printing request information for requesting to perform duplex printing to the engine control section 206.

In Steps S301 to S304, when the first and second sheets of paper are subjected to duplex printing, for example, printing request information for requesting printing for a page corresponding to the back surface of the first sheet of paper is first transmitted. Then, printing request information for respectively requesting to print an image on the back surface of the second sheet of paper, the front surface of the first sheet of paper, and the front surface of the second sheet of paper, in this order, are transmitted from the main control section 200 to the engine control section 206. Transmitting the printing request information in such an order allows, while the sheet of paper having the page corresponding to the back surface of the first sheet of paper first printed thereon is inverted by the intermediate tray 21, a page corresponding to the back surface of the subsequent second sheet of paper to be printed. In FIG. 3, characters “PAGE 1”, “PAGE 2”, etc. correspond to “a first sheet of paper”, “a second sheet of paper”, etc. (the same is true for the subsequent drawings).

The printing request information includes information relating to a source of feeding of sheets of paper and a destination of discharge of sheets of paper after printing, in addition to information indicating how many sheets of paper are there before the current sheet of paper and information representing the difference between both surfaces of the sheet of paper. For example, the printing request information relating to the back surface of the first sheet of paper includes information indicating that sheets of paper are fed from the paper feeding cassette 4 in the upper stage, and that a destination of discharge of the sheets of paper after printing is the intermediate tray 21. On the basis of this information, the engine control section 206 can specify the paper feeding cassette 4 (paper feeding stage) that should actually perform a paper feeding operation and specifically control the switching of the destination of discharge of the sheets of paper after printing.

Furthermore, the engine control section 206 controls the sections in the print engine 10 in response to the transmission of each piece of the printing request information, to cause the image forming units 150 to 156 to wait with image formation permitted.

In Steps S305 to S308, the main control section 200 transmits (transfers) image data to the engine control section 206 for respective pages corresponding to the transmitted printing request information in order. First, the main control section 200 transmits image data for forming a toner image in magenta for the back surface of the first sheet of paper. Then, the main control section 200 transmits to the engine control section 206 image data for forming toner images in cyan, yellow, and black, respectively, on the back surface of the first sheet of paper.

The engine control section 206 causes the image forming units 150 to 156 to respectively form the toner images by color on the basis of the image data transmitted from the main control section 200, and then causes the transferring section 11 to transfer the toner images on the drum photoconductors 160 onto the sheet of paper.

In the sequence so far described, the image forming apparatus 1 has already been normally performing a printing operation for the back surface of the first sheet of paper. On the other hand, the engine control section 206 then causes the cassette-type paper feeding section 3 to start to deliver the sheets of paper from the paper feeding cassette 4 in order to perform a printing operation for the back surface of the second sheet of paper (in a thread separate from the sequence shown in FIG. 3). At this time, when a paper jam occurs, the following sequence is executed between the main control section 200 and the engine control section 206.

In Step S309, when a jam occurs in the paper feeding cassette 4 in the upper stage, and jam detection information is transmitted from the jam detection section 208, the engine control section 206 transmits to the main control section 200 stop preparation information (JAM Warning) for preparing for the stop of a printing operation due to the occurrence of the jam.

In Step S310, the main control section 200 transmits, when the stop preparation information is transmitted thereto, deletion request information to the engine control section 206. The deletion request information is for requesting to delete the printing request information by which printing has not been normally terminated yet in the engine control section 206.

Upon receipt of the deletion request information, the engine control section 206 deletes, out of the printing request information that has already been received from the main control section 200, the printing request information by which printing has not been normally terminated yet. Specifically, printing has not been terminated at the present time point on the back surface of the second sheet of paper, the front surface of the first sheet of paper, and the front surface of the second sheet of paper, respectively, that have been transmitted in steps S302 to S304. Therefore, the engine control section 206 deletes the printing request information corresponding thereto.

In step S311, the engine control section 206 transmits, when it deletes the printing request information, information indicating that deletion has been completed and final page information, including information relating to the back surface of the first sheet of paper on which printing has been terminated, last at the present time point to the main control section 200. Here, even if the image on the back surface of the first sheet of paper is being actually transferred onto the sheets of paper in the print engine 10, processing may be normally performed as controlled without physically interfering with the conveyance of the sheets of paper.

In step S312, the main control section 200 determines, when it receives the information indicating that deletion has been completed and the final page information (e.g., an ID corresponding to the back surface of the first sheet of paper), that the first sheet of paper may be recovered by doping printing on the remaining front surface thereof in duplex printing for the final page, and transmits printing re-request information to the engine control section 206.

That is, the main control section 200 comprehends the contents of the final page information, and determines, when it confirms that the last printing is for the back surface of the first sheet of paper that is one surface in duplex printing and further, and no jam has occurred in the duplex printing unit 20 and the paper conveying section 6, that the first sheet of paper may be recovered by duplex printing for the final page. This means that even if the second sheet of paper jams in the paper feeding cassette 4, the first sheet of paper can be discharged (recovered) with duplex printing normally performed if printing on the remaining front surface thereof is done. In this case, the main control section 200 transmits printing re-request information for re-requesting printing on the front surface of the first sheet of paper to the engine control section 206.

In step S313, the engine control section 206 transmits, when printing is completed for the back surface of the first sheet of paper and the first sheet of paper reaches the intermediate tray 21, to the main control section 200, processing completion information. The processing completion information includes contents indicating that printing has been normally completed for the back surface of the first sheet of paper and the first sheet of paper has reached the intermediate tray 21.

In steps S314 to S317, the main control section 200 transmits image data for printing an image on the front surface of the first sheet of paper to the engine control section 206. Specifically, the main control section 200 first transmits image data corresponding to a toner image in magenta on the front surface of the first sheet of paper. Then, the main control section 200 transmits to the engine control section 206 image data corresponding to toner images by color in cyan, yellow, and black, respectively, on the front surface of the first sheet of paper in this order.

Upon receipt of the image data, the engine control section 206 operates the print engine 10, to cause the image forming units 150 to 156 to respectively form the toner images on the basis of the image data by color, and then cause the transferring section 11 to transfer the toner images on the drum photoconductors 160 onto the sheet of paper. The sheet of paper having the toner image in full color transferred thereon is heated and pressed through the embedding unit 12, and is then discharged into the paper discharge tray 14 through the paper discharging/branching section 13.

In step S318, the engine control section 206 transmits, when it confirms that duplex printing has been completed for the first sheet of paper and the first sheet of paper has reached the paper discharge tray 14, as described above, to the main control section 200 information indicating that printing has been completed.

When the sequence so far described is completed, there are no sheets of paper that can be manipulated (conveyed or discharged) after being delivered from the paper feeding cassette 4 at this time point.

In step S319, upon receipt of the fact that there are no sheets of paper that can be manipulated, the engine control section 206 transmits jam notification information for notifying the user of the occurrence of the jam to the main control section 200. The jam notification information specifically includes information indicating which of the paper feeding cassettes 4 in the upper, intermediate, and lower stages a jam has occurred in. The main control section 200 stops, when the jam notification information is transmitted thereto, the operation of each of the sections in the image forming apparatus 1 and displays information for notifying the user that a jam has occurred and the place where the jam has occurred on a display screen of the operating/display section 202. Accordingly, the main control section 200 may output an error sound from a speaker (not shown).

As described in the foregoing, in the operational example 1, even if a paper jam occurs for the second sheet of paper while duplex printing is being performed for at least the first sheet of paper, the duplex printing is not stopped until it can be reliably completed for the sheet of paper that may be recovered. In this case, desired duplex printing has been completed for all the sheets of paper discharged before the image forming apparatus 1 enters a jammed state in order to stop the operation thereof. Consequently, the discharged sheet of paper can be effectively used without being discarded, which is able to more reliably prevent paper resources and toner from being wastefully used, as compared with the related art in which the sheet of paper is discharged while printing on one surface thereof is being performed. Furthermore, the user requesting duplex printing can effectively use the sheet of paper on which the duplex printing has been done without being forcibly changed into single-sided printing using a machine.

In the sequence in the operational example 1, when there is no sheet of paper that may be recovered in the foregoing step S312, the engine control section 206 transmits jam notification information as it is (step S319). In this case, the sheet of paper that should be discharged does not particularly remain within the main body 2 of the image forming apparatus 1. Therefore, the image forming apparatus 1 enters a jammed state as it is.

### OPERATION EXAMPLE 2

An operational example 2, described below, is applicable to a form used with a finisher combined with an image forming apparatus 1. First, a description is provided of the outline of the form of the finisher combined with the image forming apparatus 1.

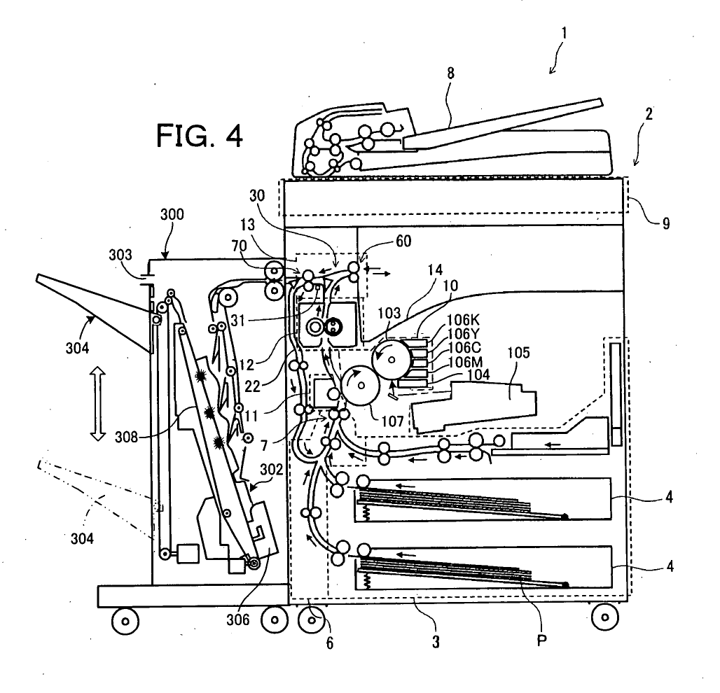

FIG. 4 is a schematic view showing an example in which a finisher 300 is combined with the image forming apparatus 1 to configure one image forming system. The image forming apparatus 1 shown in FIG. 4 is of a type having the same function of performing duplex printing in full color as that described in the operational example 1 (FIG. 1). The basic configuration thereof is the same as that shown in FIG. 1, and hence components common to those in the operational example 1 are assigned the same reference numerals, and detailed indications in the drawings and the description thereof are omitted.

The image forming apparatus 1 used in the operational example 2 includes a so-called in-trunk type paper discharge tray 14. A sheet of paper discharged from a paper discharging/branching section 13 is discharged into the paper discharge tray 14 in an upside-down state. A cassette-type paper feeding section 3 is equipped with paper feeding cassettes 4 in two upper and lower stages. It should be noted that a paper feeding cassettes 4 may be provided in upper, intermediate, and lower stages, as in the operational example 1.

Furthermore, in the operational example 2, a main body 2 in the image forming apparatus 1 is provided with a duplex printing and conveying section 22. In a case where duplex printing is not done (a case of single-sided printing), a sheet of paper discharged from a fuser 12 is discharged into the paper discharge tray 14 as it is from the discharging/branching section 13. In a case where duplex printing is done, the sheet of paper is delivered halfway toward the paper discharge tray 14 from the discharging/branching section 13 once, and is then drawn into a paper inverter 30 after the conveyance direction thereof is switched. The drawn sheet of paper is conveyed downward through the duplex printing and conveying section 22 formed along a left side surface of the main body 2, is then inverted upward at an upper position of the cassette-type paper feeding section 3, and is fed into a registration roller 7.

Furthermore, in the operational example 2, development cartridges 106M, 106C, 106Y, and 106K are arranged so as to surround one drum photoconductor 103, to develop each color toner image at their respective positions. A toner image in full color developed by the drum photoconductor 103 is primarily transferred onto an intermediate transfer roller 107.

A finisher 300 has the function of stacking and binding sheets of paper discharged from the image forming apparatus 1, and stapling and discharging the sheets of paper. The sheets of paper discharged from the image forming apparatus 1 are received in the finisher 300 through a carry-in port 301, and are stacked in a bundle shape in an overlapped manner in the thickness direction in a stacking section 302. A stapler 306 staples a bundle of stacked sheets of paper. After the stapling, the stapled bundle is raised by a conveyer 308, and is discharged into an external tray 304 from a carry-out port 303. The external tray 304 is movable up and down depending on the thickness of the bundle carried out.

Furthermore, the finisher 300 is equipped with an inherent finishing control section (not shown), a storing section, etc. They control the stapling by the stapler 306 on the basis of various types of commands (a staple command and a discharge command) from a main control section 200, and control an operation of discharging a paper bundle by the conveyer 308. In the operational example 2, a jam detection section 208 is also mounted in the finisher 300. Jam sensors (not shown) are attached to various places within the finisher 300. When the sheets of paper and their bundle jam, detection information relating thereto is transmitted to the engine control section 206.

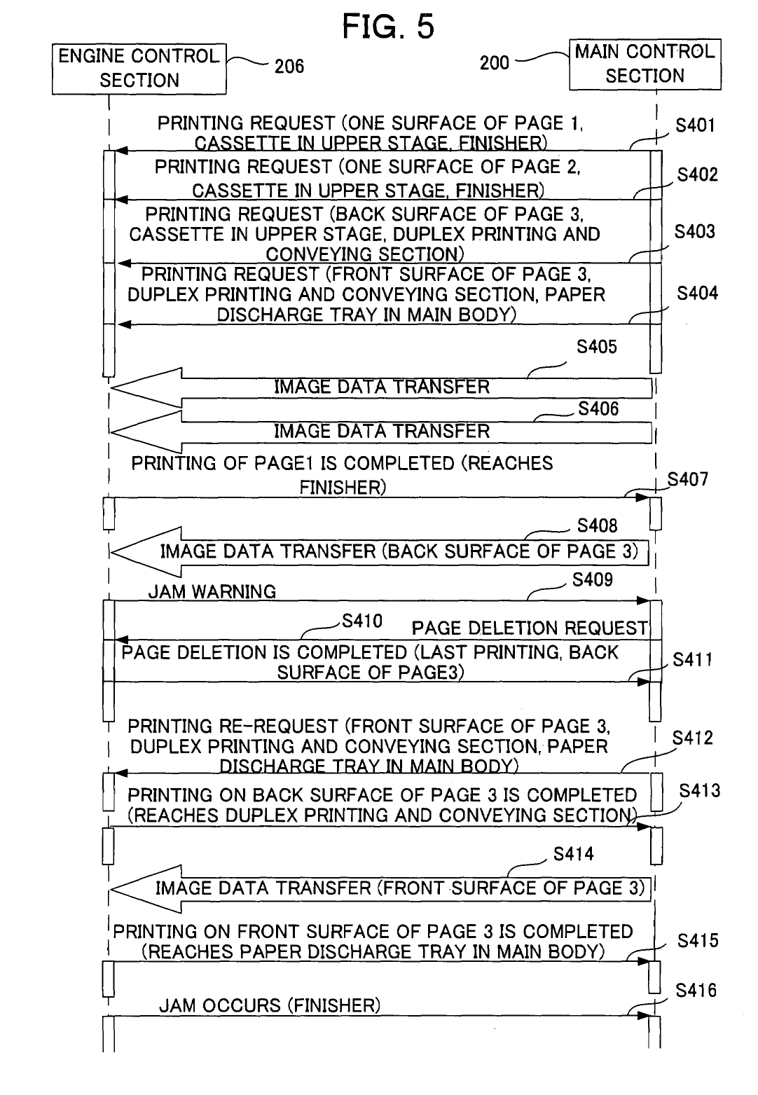

FIG. 5 is a sequential view of the operational example 2. The operational example 2 assumes a case in which, during running of a job for first discharging two sheets of paper (corresponding to two pages in this case) into the finisher 300 in single side printing, and then discharging one sheet of paper into the discharge tray 14 in the main body 2 in duplex printing, the second sheet of paper jams within the finisher 300. In the following description, the redundant description of items common to those in the operational example 1 is omitted, as needed.

In steps S401 to S404, the abovementioned job is based on contents designated by a user, for example. That is, when the user respectively designates single-sided printing and duplex printing using the operating/display section 202, and presses a start key, the main control section 200 is responsive to this operation to transmit to the engine control section 206 printing request information for respectively requesting single-sided printing and duplex printing. When the first and second sheets of paper are subjected to single-sided printing, and the third sheet of paper is subjected to duplex printing, for example, printing request information for requesting to print an image on one surface of the first sheet of paper is first transmitted. The main control section 200 then transmits printing request information for requesting to respectively print images corresponding to one surface of the second sheet of paper, the back surface of the third sheet of paper, and the front surface of the third sheet of paper in this order.

In the operational example 2, the printing request information includes information representing the difference between both surfaces in the case of duplex printing and information relating to a source feeding sheets of paper and a destination of discharge thereof after printing, in addition to information indicating how many sheets of paper are there before the current sheet of paper and information representing the distinction between duplex printing and single-sided printing. For example, the printing request information relating to the first sheet of paper in single-sided printing includes information indicating that sheets of paper are fed from the paper feeding cassette 4 in the upper stage, and the finisher 300 is taken as the destination of discharge of the sheets of paper after printing in addition to information indicating that this is single-sided printing. On the basis of this information, the engine control section 206 specifies the paper feeding cassette 4 (paper feeding stage) that should actually perform a paper feeding operation and specifically controls the switching of the destination of discharge of the sheets of paper after printing.

The engine control section 206 controls the sections in the print engine 10 in response to the transmission of each piece of the printing request information, to cause a charger 104, an exposure device 105, the developing units 106M to 106K, the intermediate transfer roller 107, etc. to wait with the image formation allowed.

In steps S405 and S406, the main control section 200 transmits image data to the engine control section 206 for pages corresponding to the transmitted printing request information in order. First, the main control section 200 transmits image data corresponding to a monochrome toner image, for example, for only one surface of the first sheet of paper. Then, the main control section 200 transmits to the engine control section 206 the image data corresponding to the monochrome toner image for only one surface of the second sheet of paper. Although the monochrome image is taken as an example, the image data may be transmitted for each of the colors such as magenta, cyan, yellow, and black, as in the operational example 1.

The engine control section 206 causes the monochrome toner image to be transferred onto the intermediate transfer roller 107 on the basis of the image data transmitted from the main control section 200. Then, the engine control section 206 causes the transferring section 11 to transfer the toner image on the intermediate transfer roller 107 onto the sheet of paper.

In step S407, when single-sided printing on the first sheet of paper is completed, the sheet of paper is delivered to the finisher 300 through the paper discharging/branching section 13. The engine control section 206 transmits, when it confirms that printing has been completed for the first sheet of paper and the first sheet of paper has reached the finisher 300, information indicating that the first sheet of paper for which printing has been completed has reached the finisher 300 to the main control section 200.

In step S408, the main control section 200 transmits, when it receives the previous information, image data (a monochrome image) corresponding to the back surface of the third sheet of paper.

Similarly, the engine control section 206 causes the toner image to be transferred onto the intermediate transfer roller 107 on the basis of the image data transmitted from the main control section 200. Then, the engine control section 206 causes the transferring section 11 to transfer the toner image on the intermediate transfer roller 107 onto the sheet of paper.

In the sequence so far described, the image forming apparatus 1 is normally performing a printing operation for the back surface of the third sheet of paper successively after printing on one surface of each of the first and second sheets of paper has already been terminated. The first and second sheets of paper on which printing has been performed are discharged into the finisher 300 on the basis of the printing request information.

On the other hand, the engine control section 206 causes the cassette-type paper feeding section 3 to start to deliver the sheets of paper from the paper feeding cassette 4 in order to perform a printing operation for the back surface of the third sheet of paper (in a thread separate from the sequence in FIG. 5). Although the operational example 1 assumes a case where a paper jam occurs at this moment, the third sheet of paper is normally fed, and printing on the back surface thereof is done as it is in the operation example 2. However, the operational example 2 assumes a case in which the second sheet of paper that has been previously discharged into the finisher 300 jams. When a jam thus occurs within the finisher 300, the following sequence is executed between the main control section 200 and the engine control section 206.

In step S409, when a jam occurs in the finisher 300, and jam detection processing is transmitted from the jam detection section 208, the engine control section 206 transmits stop preparation information to the main control section 200 for preparing for the stop of a printing operation due to the occurrence of the jam.

In step S410, the main control section 200 transmits, when the stop preparation information is transmitted thereto, deletion request information to the engine control section 206. Similar to the operational example 1, the deletion request information is for requesting the deletion of the printing request information by which printing has not been normally performed yet.

Upon receipt of the deletion request information, the engine control section 206 deletes, out of the printing request information that has already been received from the main control section 200, the printing request information by which printing has not been normally terminated yet. Specifically, printing has not been terminated at the present point in time on the front surface of the third sheet of paper that has been transmitted in step S404. Therefore, the engine control section 206 deletes the printing request information corresponding thereto.

In step S411, the engine control section 206 transmits, when it deletes the printing request information, information indicating that deletion has been completed and final page information including information relating to the back surface of the third sheet of paper on which printing has been terminated last at the present point in time to the main control section 200.

In step S412, the main control section 200 determines, when it receives the information indicating that deletion has been completed and the final page information (e.g., an ID corresponding to the back surface of the third sheet of paper), that the third sheet of paper may be recovered by performing printing on the remaining front surface in duplex printing for the final page, and transmits printing re-request information to the engine control section 206. The main control section 200 comprehends the contents of the final page information, and determines, when it confirms that the last printing is for the back surface of the third sheet of paper that is one surface in duplex printing, and further that no jam has occurred in the duplex printing and conveying section 22 and the paper conveying section 6, that the third sheet of paper may be recovered by duplex printing for the final page. This means that even if the second sheet of paper on which printing has already been terminated jams within the finisher 300, the third sheet of paper can be discharged (recovered) with duplex printing normally performed if printing on the remaining front surface thereof is done. In this case, the main control section 200 transmits, to the engine control section 206, printing re-request information for re-requesting printing on the front surface of the third sheet of paper.

In step S413, the engine control section 206 transmits, when printing is completed for the back surface of the third sheet of paper and the third sheet of paper reaches the duplex printing and conveying section 22, processing completion information to the main control section 200. The processing completion information includes contents indicating that printing has been normally completed for the back surface of the third sheet of paper and the third sheet of paper has reached the duplex printing and conveying section 22.

In step S414, the main control section 200 transmits to the engine control section 206 image data for printing an image on the front surface of the third sheet of paper.

Upon receipt of the image data, the engine control section 206 operates the print engine 10, and forms toner images on the basis of the received image data, firstly transfers the toner images on the intermediate transfer roller 107, and causes the transferring section 11 to secondly transfer the toner images on the intermediate transfer roller 107 onto the sheet of paper. The sheet of paper having the toner images transferred thereon is heated and pressed through the fixing section 12, and is then discharged into the paper discharge tray 14 in the main body 2 through the paper discharging/branching section 13.

In step S415, the engine control section 206 transmits, when it confirms that duplex printing has been completed for the third sheet of paper and the third sheet of paper has reached the paper discharge tray 14 in the main body 2, as described above, information indicating that printing has been completed to the main control section 200.

When the sequence so far described is completed, there are no sheets of paper that can be operated (conveyed or discharged) after being delivered from the paper feeding cassette 4 at this point in time.

In step S416, upon receipt of the fact that there are no sheets of paper that can be manipulated, the engine control section 206 transmits jam notification information to the main control section 200 for notifying the user of the occurrence of the jam. The jam notification information specifically includes information indicating that a jam has occurred within the finisher 300. The main control section 200 stops, when the jam notification information is transmitted thereto, the operation of each of the sections in the image forming apparatus 1, and displays information for notifying the user that a jam has occurred and a place where the jam has occurred (the finisher 300) on a display screen of the operating/display section 202. Accordingly, the main control section 200 may output an error sound from a speaker (not shown).

As described in the foregoing, in the operational example 2, even if the sheet of paper on which single-sided printing has been previously performed is discharged into the finisher 30, and a jam then occurs within the finisher 300 while duplex printing is being performed for at least the subsequent sheet of paper, the duplex printing is not stopped until it can be reliably completed for the sheet of paper that may be recovered. In this case, the desired duplex printing has been completed for the sheets of paper discharged before the image forming apparatus 1 enters a jammed state to stop the operation thereof. Consequently, the user can effectively use the discharged sheet of paper without discarding the sheet of paper, which can more reliably prevent paper resources and toner from being wastefully used, as compared with the related art in which the sheet of paper is discharged while printing on one surface thereof has been performed. Furthermore, the user that requests duplex printing can effectively use the sheet of paper on which duplex printing has been done without being forcibly changed into single-sided printing using a machine.

In the sequence in the operational example 2, when there is no sheet of paper that may be recovered in the foregoing step S412, the engine control section 206 transmits jam notification information as it is (step S416). In this case, the sheet of paper that should be discharged does not particularly remain within the main body 2 of the image forming apparatus 1. Therefore, the image forming apparatus 1 enters a jammed state as it is.

### OPERATION EXAMPLE 3

A sequence in an operational example 3 is next described. The sequence in the operational example 3 is applicable to both a case of only the image forming apparatus 1 shown in FIG. 1 and a case where the image forming apparatus 1 is configured as an image forming system shown in FIG. 4. Here, the image forming apparatus 1 shown in FIG. 1 is described by way of example.

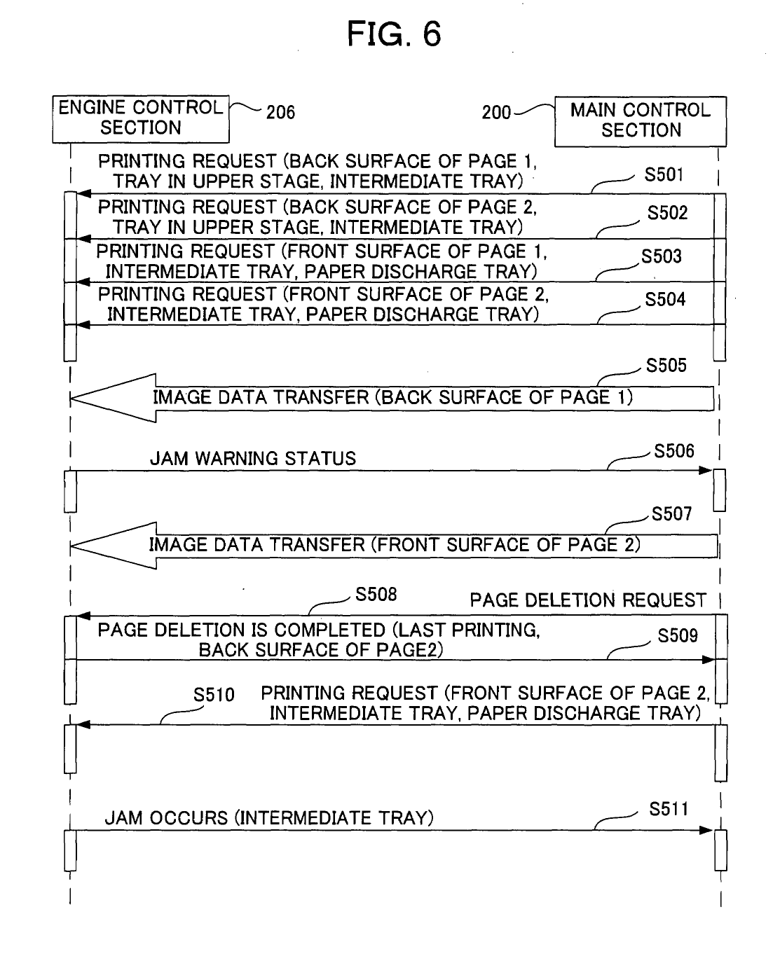

FIG. 6 is a sequential view of the operation example 3. The operational example 3 assumes a case where the first sheet of paper jams within the duplex printing unit 20 while duplex printing corresponding to four sheets of paper is being performed according to a certain job. Under circumferences assumed in the operational example 3, a jam occurs within the duplex printing unit 20. Therefore, duplex printing cannot be completed for all sheets of paper that can be manipulated (or conveyed), as described in the operational examples 1 and 2.

Therefore, in the operational example 3, a sequence in which it is assumed that the second sheet of paper, which can be manipulated within the image forming apparatus 1, is forcibly discharged into the paper discharge tray 14 with the sheet of paper subjected to single-sided printing is presented. In the following description, the redundant description of items common to those in the operational example 1 is omitted, as needed.

In steps S501 to S504, the main control section 200 transmits to the engine control section 206 printing request information for requesting duplex printing. In the abovementioned job, when each of the first to fourth sheets of paper is subjected to duplex printing, printing request information for requesting printing on the back surface of the first sheet of paper is first transmitted. Then, printing request information for requesting to print images on the back surface of the second sheet of paper, the front surface of the first sheet of paper, and the front surface of the second sheet of paper in this order is transmitted from the main control section 200 to the engine control section 206.

In step S505, the main control section 200 transmits image data to the engine control section 206 for pages to which the printing request information has been transmitted in order. Here, the main control section 200 first transmits image data corresponding to a monochrome toner image, for example, for the back surface of the first sheet of paper.

The engine control section 206 causes the image forming unit 156 to form the monochrome toner image on the basis of the image data transmitted from the main control section 200. Then, the engine control section 206 causes the transferring section 11 to transfer the toner images on the drum photoconductor 160 onto the sheet of paper.

In the sequence so far described, the image forming apparatus 1 has already been normally performing a printing operation for the back surface of the first sheet of paper. The first sheet of paper having the image printed on its back surface is then delivered to the duplex printing unit 20 from the paper discharging/branching section 13 in preparation for a printing operation for the front surface thereof on the basis of the printing request information relating thereto.

On the other hand, the engine control section 206 then causes the cassette-type paper feeding section 3 to start to deliver the sheets of paper from the paper feeding cassette 4 in order to perform a printing operation for the back surface of the second sheet of paper (in a thread separate from the sequence shown in FIG. 6). The operational example 3 assumes a case where the first sheet of paper that has been previously discharged into the duplex printing unit 20 jams without jamming in the paper feeding cassette 4. When a jam thus occurs within the duplex printing unit 20, the second sheet of paper can be successively operated. However, the second sheet of paper cannot be delivered to the duplex printing unit 20. Therefore, the following sequence is executed between the main control section 200 and the engine control section 206.

In step S506, when a jam occurs in the duplex printing unit 20, and jam detection information is transmitted from the jam detection section 208, the engine control section 206 transmits stop preparation information to the main control section 200 in preparation for the stop of a printing operation due to the occurrence of the jam.

In step S507, even if the stop preparation information is transmitted from the engine control section 206 to the main control section 200, the main control section 200 transmits, if it has image data to be transmitted, the image data to the engine control section 206. Specifically, the main control section 200 transmits to the engine control section 206 image data corresponding to the back surface of the second sheet of paper subsequently to the image data corresponding to the back surface of the first sheet of paper transmitted in step S505. At this time, the second sheet of paper has already been normally delivered from the paper feeding cassette 4 and can be successively manipulated (conveyed) within the image forming apparatus 1. Therefore, printing must be completed once for the back surface.

The engine control section 206 causes the image forming unit 156 to form the toner image on the basis of the image data corresponding to the back surface of the second sheet of paper transmitted from the main control section 200. Then, the engine control section 206 causes the transferring section 11 to transfer the toner image on the drum photoconductor 160 onto the sheet of paper.

In step S508, at approximately that time, the main control section 200 transmits, when the stop preparation information is transmitted thereto, deletion request information to the engine control section 206.

Upon receipt of the deletion request information, the engine control section 206 deletes, out of the printing request information that have already been received from the main control section 200, the printing request information by which printing has not been normally terminated yet. Specifically, printing has not been terminated at the present point in time on the respective front surfaces of the first and second sheets of paper transmitted in steps S503 and 504, respectively. Therefore, the engine control section 206 deletes the printing request information corresponding thereto.

In step S509, the engine control section 206 transmits, when it deletes the printing request information, information indicating that deletion has been completed and final page information including information relating to the back surface of the second sheet of paper on which printing has been terminated last at the present time point to the main control section 200.

In step S510, the main control section 200 determines, when it receives the information indicating that deletion has been completed and the final page information (e.g., an ID corresponding to the back surface of the second sheet of paper), that the second sheet of paper may be recovered by performing printing on the remaining front surface in duplex printing for the final page, and transmits printing re-request information corresponding to the front surface of the second sheet of paper to the engine control section 206. Inn the operational example 3, a jam occurs in the duplex printing unit 20; however, the abovementioned possibility is only tentative. Therefore, it is judged that recovery is impossible in the subsequent processes.

The engine control section 206 judges, when it confirms that a place in which a jam has occurred is the duplex printing unit 20 from the contents of the jam detection information even though it receives the printing re-request information for requesting printing on the front surface of the second sheet of paper, that the printing on the front surface of the second sheet of paper cannot be continued (recovery is impossible).

As a result, the engine control section 206 does not do printing on the front surface of the second sheet of paper, but forcibly discharges into the paper discharge tray 14 in the main body 2 the second sheet of paper having an image printed on only its back surface, the sheet of paper being subjected to single-sided printing. Thus, there are no sheets of paper that can be manipulated (conveyed or discharged) after being delivered from the paper feeding cassette 4, irrespective of the suitability for the result of the printing.

In step S511, upon receipt of the fact that there are no sheets of paper that can be manipulated, the engine control section 206 transmits jam notification information to the main control section 200 for notifying the user of the occurrence of the jam. The notification information specifically includes information indicating that a jam has occurred in the duplex printing unit 20. The main control section 200 stops, when the jam notification information is transmitted thereto, the operation of each of the sections in the image forming apparatus 1, and displays information for notifying the user that a jam has occurred and a place where the jam has occurred (the duplex printing unit 20) on a display screen of the operating/display section 202.

As described in the foregoing, in the operational example 3, when a request to perform duplex printing for at least two sheets of paper is issued, even if a jam occurs in the duplex printing unit 20 after single sided printing is completed for the sheets of paper previously fed and at least the subsequent sheet of paper is normally fed, the printing is not stopped until it can be reliably completed for the one surface of the sheet of paper that can be manipulated. In this case, when the image forming apparatus 1 enters a jammed state to stop the operation thereof, all the sheets of paper that can be manipulated inside are discharged. Consequently, the user (or worker) may only perform work for removing the sheet of paper that has jammed in the duplex printing unit 20. Thereafter, the image forming apparatus 1 can be quickly restored to its normal state.

When the image forming apparatus 1 is restored to a state where a printing operation can be performed after the cause of the jam is removed, the main control section 200 transmits the printing request information, starting with the first sheet of paper.

### ANOTHER EMBODIMENT

Although in the present embodiment the foregoing configuration is applied to the image forming apparatus 1 serving as a copying machine, the present invention is also applicable to image forming apparatuses such as a printer and a facsimile transmitter-receiver that perform duplex printing and multifunctional peripheral equipment (MFP) used in a network environment.

The contents of the jobs described in the respective operational examples are merely preferable examples. The present invention is also applicable to a job having other contents. Furthermore, the job may be run not only by a user's operation by way of the operating/display section 202, but also by transmission from a computer connected to a network, for example.

In addition thereto, the respective configurations of various types of sections in the image forming apparatus 1 and the finisher 300 are preferable examples. The present invention is also applicable even if the configurations are changed, as needed.

What is claimed is:

1. An image forming apparatus having an image forming section for forming a unit-page image on the basis of image data processed that prints the unit-page image formed in the image forming section on one surface of a sheet of paper, then also prints the unit-page image on the other surface of the same sheet of paper, and discharges the sheet of paper, comprising:
a printing control means for controlling a printing operation performed by the image forming section;
a printing request means for requesting the printing control means to print the unit-page image for each surface of the sheet of paper;
a paper feed means for feeding a required number of sheets of paper one at a time to the image forming section in response to the request to the printing control means from the printing request means;
an inversion and feed means for inverting, when the printing request means requests to print the image on both surfaces of the one sheet of paper, the sheet of paper having the image printed, by the image forming section, on one surface thereof and feeding the sheet of paper to the image forming section with printing on the other surface thereof allowed;
a jam detecting means for detecting as a jam an obstruction that has occurred in the process of paper feeding by the paper feeding means; and
a duplex printing completion means for completing, when the sheet of paper having the image printed, by the image forming section, on one surface thereof exists at the point in time when the jam detecting means detects the jam, the printing on the other surface thereof.

2. The image forming apparatus according to claim 1, further comprising
a request cancellation means for cancelling, even if the printing request means has already requested the printing control means to perform printing when the jam detection means detects the jam, the request for which the image forming section has not performed a printing operation yet;
a printing re-request means for re-requesting, when the request cancellation means cancels the request, the printing control means to perform a printing operation for the other surface of the sheet of paper having the image printed, by the image forming section, on one surface thereof; and
a jam occurrence notification means for stopping, when the printing operation based on the re-request from the printing re-request means is terminated, the subsequent printing operation by the image forming section, and notifying a user of the occurrence of the jam.

3. The image forming apparatus according to claim 2, further comprising
a control means serving as the printing request means, the request cancellation means, and the printing re-request means,
wherein the printing control means transmits, when the jam detection means detects the jam, a stop preparation signal to the control means in preparation for the stop of a subsequent printing operation by the image forming section, and
the control means serves as the request cancellation means and the printing re-request means in response to receiving the stop preparation signal.

4. The image forming apparatus according to claim 1, further comprising a finishing section for performing predetermined finishing process of the sheet of paper discharged with the printing operation by the image forming section completed,
wherein the jam detection means further detects as a jam an obstruction that has occurred in the process of the finishing process performed on the sheet of paper discharged into the finishing section.

5. The image forming apparatus according to claim 1, wherein the jam detection means detects as a duplex printing jam an obstruction that has occurred in the process of feeding the sheet of paper having the image printed on one surface thereof by the inverting and feeding means;
and further comprising a forcibly discharge means for discharging, when a sheet of paper having no problem exists in the process of paper feeding by the paper feeding means at the point in time when the jam detection means detects the duplex printing jam, the sheet of paper with printing on one of the surfaces of the sheet of paper performed by the image forming section even if the printing request means requests printing on both of the surfaces thereof.
